(19) United States
(12) Patent Application Publication
(10) Pub. No.: US 2005/0254473 A1
(43) Pub. Date: Nov. 17, 2005

(54) Routing within a mobile communication network

(75) Inventors: Christophe Preguica, Massy (FR); Jean-Pierre Rombeaut, Maubeuge (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/128,340

(22) Filed: May 13, 2005

(30) Foreign Application Priority Data
May 17, 2004 (FR) 04 50 954

(51) Int. Cl. H04Q 7/24; H04J 3/00; H04L 12/28; H04L 12/56

(52) U.S. Cl. 370/338; 370/345

(57) ABSTRACT

The invention concerns a mobile device comprising communication means for transmitting data packets to other mobile devices within a first cluster within a mobile communication network, which also includes: Detection means (DM) for detecting a new mobile device belonging to a second cluster, Election means (EM) for determining whether this new device should or should not be added to the membership of an inter-cluster subnetwork,
Second routing means (RM2) for transmitting routing information between the devices that are members of the inter-cluster subnetwork, Communication means (CM) for exchanging routing information between the first and second routing means.

The present invention relates to mobile networks in which at least some of the network nodes are mobile in relation to each other and whose architecture is not defined once and for all. It more specifically concerns routing within such networks, in other words the transmitting of information allowing the routing of data within these networks.

Works on these mobile networks are grouped within the IETF (Internet Engineering Task Force) in a working group known as MANET (Mobile Ad-hoc Network). According to these works, the network does not require a fixed infrastructure and may therefore function if all the nodes are mobile. Such networks are known as ad-hoc networks or ad-hoc mobile networks.

In ad-hoc networks, as in fixed networks based on the Internet Protocol family, the network's operation is not entirely fixed at the start: the transmission of data packets over the network takes place on the basis of “routes”, defined by routing protocols. These routes may be different from one packet to the next between two given points.

There are currently different routing protocols for ad-hoc networks, in particular those defined by the MANET working group. These include the AODV, OLSR, DSR and TBRPF protocols.

Some of these routing protocols are “proactive”. A routing protocol is said to be proactive if the network's information is constantly exchanged so that when a route is requested it is immediately available. These proactive protocols differ from reactive protocols, according to which routes are calculated on request, in other words when a data packet needs routing.

The TBRPF and OLSR protocols are two examples of proactive protocols. The TBRPF protocol is described by IETF RFC 3684, entitled “Topology Dissemination Based on Reversed-Path Forwarding (TBRPF). The OLSR (Optimized Link-State Routing) is defined by IETF RFC 3626.

These proactive protocols present a major disadvantage, however. They are based on a Dijkstra algorithm and therefore result in a combinatory explosion if the number of nodes in the network increases. The nodes' resources are therefore mainly used by this routing protocol for the calculating of routes, to the detriment of their primary data packet routing function. Although this figure depends on the processing capacity of the network nodes, it may be estimated that if there are more than 500 nodes in the network, these routing protocols can no longer be used with satisfactory performances.

This major fault is shared by existing proactive protocols (TBRPF or OLSR) and future ones if they use a Dijkstra type algorithm or any other routing algorithm whose complexity grows exponentially with the number of nodes in the network.

The patent application U.S. 2004/0033111 entitled “Protocol and Structure for Self-Organizing Network” defines a new protocol for resolving the problem of the limitations of existing algorithms. Owing to this alone, the solution proposed is incompatible with existing protocols (OLSR protocols, for example). They therefore require the complete redevelopment of devices, which will in any case then be incompatible with the networks already deployed.

Aside from this major disadvantage, the solution rests on the fixed determination of a particular node (“cluster head”) for each cluster and on a tree structure organisation of the nodes within each cluster.

This solution therefore resembles that set out in American patent request U.S. 2004/0081152 entitled “Arrangement for Router Attachments Between Roaming Mobile Routers in a Clustered Network”. This describes a solution to this problem, in which the network is organised into clusters. Each cluster's nodes are organised in a tree structure whose root is a particular node, known as the TLMR, or the “Top Level Mobile Router”. These TLMR nodes are responsible for transmitting traffic and routing information from one cluster to another.

However, this approach poses several problems, that are for the most part shared with the approach in application U.S. 2004/003111.

First of all, all the traffic originating from a node passes through a single TLMR node. This results in the overloading of the node, causing poor network performances once the network becomes a substantial size.

The traffic is also transmitted from one cluster to another through tunnels. Once again, the time required for the encapsulation and de-encapsulation of the packets reduces the network's performances.

Furthermore, such an architecture is, by its design, extremely sensitive to faults: if a cluster's TLMR is not functioning, the entire cluster will then be isolated from the rest of the network.

Another disadvantage is that the nodes are organised in a tree structure within each cluster. This means that even if it is close to the TLMR, a node's packets must travel up the entire tree to reach the TLMR node. This once more results in a reduction of the communication network's performances.

Finally, and above all, the solution proposed is entirely static. The TLMR is fixed by configuration, so that the network cannot react to changes in traffic or its spatial organisation. Yet again this effects the network's performances.

The objective of the present invention is the overcoming of these disadvantages by allowing a mobile network to be managed ad-hoc, regardless of the number of nodes within the network, dynamically and in such a way as to optimise performances.

To this end, the invention first of all concerns a communication network consisting of mobile devices, which is formed from a set of clusters interconnected by inter-cluster subnetworks. Each mobile device within these clusters exchanges routing messages, through first routing means, with other routing devices within its cluster. Some of these mobile devices also exchange routing messages, through second routing means, with the mobile devices belonging to an inter-cluster subnetwork.

The invention also concerns a mobile network device comprising communication means for transmitting data packets to one or several other mobile devices within a first cluster within a communication network, according to routing information exchanged with said other devices through a first routing means in accordance with a first routing protocol. This mobile device also consists of:
Means for detecting a new mobile device belonging to a second mobile communication network cluster,
Means for determining according to an election policy whether the new mobile device should or should not be added to the membership of an inter-cluster subnetwork,
Second routing means for transmitting routing information between the mobile devices that are members of the inter-cluster subnetwork,
Communication means for transmitting the routing information exchanged by the first routing means to the mobile devices that are members of the inter-cluster subnetwork, and for transmitting to the first routing means the routing information received from said mobile devices that are members of said inter-cluster subnetwork, as well as information relating to the inter-cluster subnetwork, in accordance with a second routing protocol.

According to one alternative, the mobile network device also has naming means for determining whether the communication means should or should not be implemented in accordance with a naming policy.

According to one implementation of the invention, the first routing protocol and the second routing protocol are proactive. They may, for example, be similar and in particular of the TBRPF or OLSR type.

According to one alternative, if the communication means is implemented by the naming means, the routing information contains information messages consisting of:
A mobile device identifier,
An inter-cluster subnetwork identifier,
The number of mobile devices belonging to the cluster and to the inter-cluster subnetwork,
The list of all the known inter-cluster subnetworks.

The invention also concerns a process for transmitting data packets from a mobile network device to one or several other mobile devices within a first cluster within a mobile communication network, according to routing information exchanged during a first stage, with said other device(s) through first routing means (RM1) in accordance with a first routing protocol. This process also consists of the following stages:
Detecting of a new mobile device belonging a second mobile communication network cluster,
Election to determine, according to an election policy, whether said new mobile device should or should not be added to the membership of an inter-cluster subnetwork,
Transmitting of routing information between mobile devices that are members of the inter-cluster subnetwork,
Communicating of the routing information exchanged during the first stage, to mobile devices that are members of the inter-cluster subnetwork, and transmitting to the first routing means of the routing information received from the mobile devices that are members of the inter-cluster subnetwork, as well as information relating to the inter-cluster subnetwork, in accordance with a second routing protocol.

According to one alternative, the process also includes a naming stage for determining whether said communication stage should or should not be implemented in accordance with a naming policy.

According to one implementation of the invention, the first routing protocol and the second routing protocol are proactive. These may, for example, be similar protocols, in particular of the TBRPF or OLSR type.

According to one alternative, if the communication stage is implemented, the routing information contains information messages consisting of:
A mobile device identifier,
An inter-cluster subnetwork identifier,
The number of mobile devices belonging to the cluster and to the inter-cluster subnetwork,
The list of all the known inter-cluster subnetworks.

Thanks to the invention, even if each cluster's size is limited by routing protocol constraints, the possibility of having multiple clusters and connecting them to create a network, by means of inter-cluster subnetworks, allows this size limitation to be overcome.

Amongst other advantages, the invention therefore allows the transmitting of routing information within a communication network, regardless of its size.

Furthermore, thanks to the election means, the invention allows dynamic adapting to circumstances. It therefore allows the optimising of resources, the dividing of traffic between several elected devices, the offering of redundancy, etc.

The invention and its advantages will be more clearly explained in the description that follows, which refers to the figures appended:

FIG. 1 diagrams the functional architecture of a mobile network device, according to the invention.

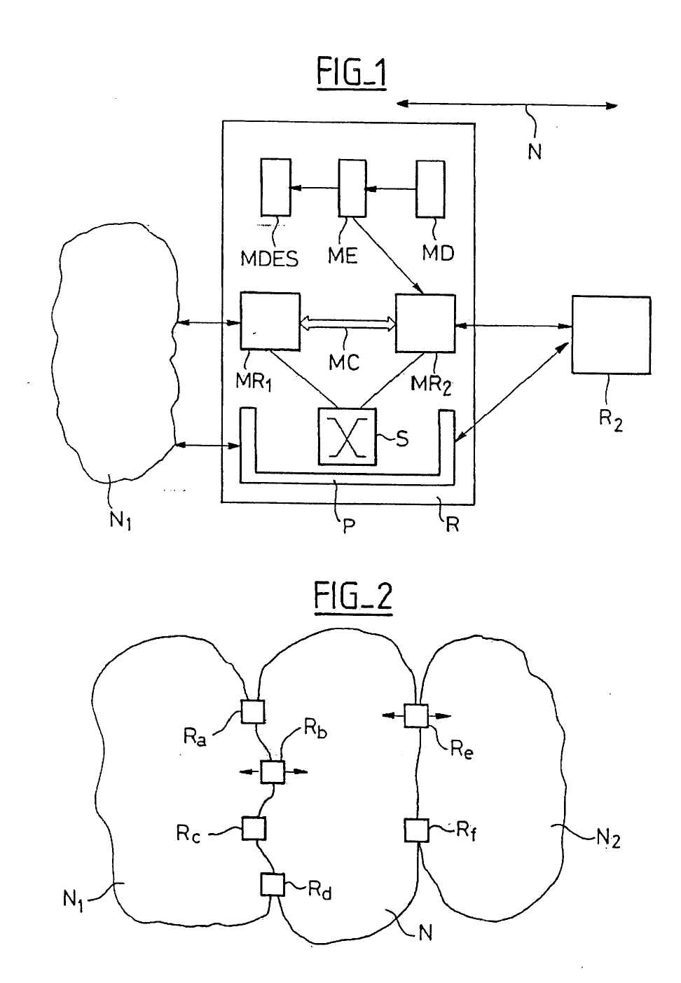

FIG. 2 shows two clusters connected by an inter-cluster subnetwork.

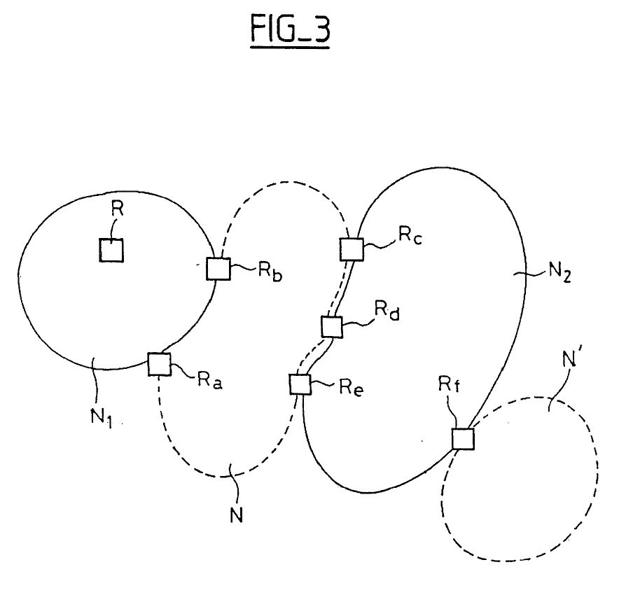

FIG. 3 illustrates the propagation of information messages within a network consisting of two clusters and two inter-cluster subnetworks.

Functional Architecture of the Mobile Device

The device R illustrated in FIG. 1 is connected to a cluster N₁ by means of a set of communication ports P. Using a known practice, these communication ports P are connected together by means of a connection matrix S, allowing the switching of the data packets received on a first port to a second port. To carry out this switching, the connection matrix uses a routing table added to by routing modules.

The mobile device R has first routing means RM₁ that implements a first proactive routing protocol. This may, for example, be the TBRPF protocol, or the OLSR protocol, both previously referred to.

This first routing means RM₁ allows the exchanging of routing information with one or several other mobile devices belonging to the cluster N₁. This exchanging gives the mobile device sufficient knowledge about the network to allow it to correctly route the data packets received, in other words correctly add to the routing table to allow appropriate switching by the connection matrix S.

The mobile device R also has detection means DM to allow the detection of a new mobile network device R₂. This new device does not belong to cluster N₁, but may belong to a second cluster, not shown in the figure.

For example, this element periodically transmits a message named “hello” consisting of information about itself and indicating its existence to other devices within radio range. When the detection means DM of the mobile device R receives such a message, it consults a database to determine whether or not this device is known. This database may, for example, be the routing table or FIB (Forwarding Information Base) of the device R.

If this mobile device does not belong to this routing table it must therefore be a new mobile device.

Within the context of the invention's implementation for the TBRPF protocol, this “hello” message may be of the type “DA Hello”.

The mobile device R also includes election means EM for determining, in accordance with an election policy, whether this new mobile device R₂ should or should not be added to the membership of an inter-cluster subnetwork N. Generally speaking, it therefore allows the “electing” of a new mobile device to the membership of an inter-cluster subnetwork. This subnetwork may be created at this time or be previously existing.

These election means may also be able to make other decisions, such as, for example, removing the mobile device from a previously existing inter-cluster subnetwork.

Consequently, the election means allows dynamic adapting to the circumstances.

The way in which thess election means EM operates will be explained further on in the section entitled “election means”.

The election means may give instructions to second routing means RM₂ for it to take care of the exchanging of routing information within the inter-cluster subnetwork indicated by the election means E_{M}, or alternatively cease its routing activity and move to an inactive state.

The routing protocol implemented by the second routing means RM₂ may be the same or different from that implemented by the first routing means RM₁. If they are the same, the two routing means may be two instances of the same software application. They also have communication means (CM) for communicating routing information to each other, in order to allow the propagation of routing information from the first cluster N₁ to the inter-cluster subnetwork N and vice versa. The nature of the routing information and the way in which it is propagated will be explained further on.

According to one implementation of the invention, the mobile device R may also have naming means NAMM. This naming means are implemented if a new mobile device R₂ has elected another mobile device to the membership of a newly created or previously existing inter-cluster subnetwork N. This naming means are able to decide whether the communication means should or should not be implemented, in accordance with a naming policy, in other words whether the two routing means should or should not exchange routing information.

This means that, according to the naming policy, the mobile device R may or may not allow the transmitting of routing information between the first cluster N₁ and the inter-cluster subnetwork N.

This solves the additional problem of the limiting of the flows formed by the routing information by only giving the “relay” function to a restricted number of mobile devices.

FIG. 2 diagrams two clusters N₁ and N₂ and an inter-cluster subnetwork N connecting these two clusters.

Four mobile devices within the cluster N₁ have been “elected” to also be members of the inter-cluster subnetwork N: these are the mobile devices Rₐ, R_{b}, R_{c} and R_{d}. They form a kind of “boundary” between the cluster N₁ and the inter-cluster subnetwork N. Of these 4 mobile devices, only the device R_{b} is named. The routing information will therefore only be transmitted by this device, between cluster N₁ and the inter-cluster subnetwork N. However, each mobile device within cluster N₁ usually routes the routing information within the cluster N₁ and each mobile device elected also routes the routing information within the inter-cluster subnetwork N.

Similarly, two devices Rₑ and R_{f} within the cluster N₂ have been “elected” to also be members of the inter-cluster subnetwork N. Of these 2 mobile devices, only the device Rₑ is named. The routing information will therefore only be transmitted by this device, between cluster N₂ and the inter-cluster subnetwork N. However, as previously for cluster N₁, each mobile device within cluster N₂ usually routes the routing information within cluster N₂ and each elected mobile device also routes the routing information within the inter-cluster subnetwork N.

Thus, by means of the named devices Rₐ and R_{b}, routing information may be transmitted between clusters N₁ and N₂ over the inter-cluster subnetwork N.

For each of the mobile devices, it is the naming means (NAMM) that determine whether the communication means (CM) should or should not be implemented to allow the exchanging of routing information between the two routing means and therefore between the cluster and the inter-cluster subnetwork.

Election Means

The purpose of the election means EM, shown on FIG. 1, is to determine whether a mobile device should or should not be part of a boundary between a cluster and an inter-cluster subnetwork.

In particular, it is implemented through a mobile device R if a new mobile device R₂ is detected by the detection means DM. In such a case it determines whether this new mobile device should or should not be added to the membership of an inter-cluster subnetwork. As previously explained, this subnetwork may be created at this time or be previously existing.

The election means may implement various election policies. According to one alternative, this election policy may be as follows:

Several cases may arise depending on the situation of the mobile devices R and R₂.

In the first 3 situations considered, it is assumed that there is no inter-cluster subnetwork connecting the clusters to which the mobile devices belong. It is also assumed that the two mobile devices belong to two separate clusters.

In the first situation, the mobile devices R and R₂ do not belong to an inter-cluster subnetwork.

Each of the mobile devices R and R₂ in this case decides to create an inter-cluster subnetwork to which they will both belong.

In this situation, they exchange an information message listing all the inter-cluster subnetworks of which they have knowledge through a routing protocol that will be described further on.

These information messages will be explained further on in the description.

In this list, the inter-cluster subnetworks are identified with numbers, for example. The election policy may consist of choosing the smallest number that has not already been allocated to a known inter-cluster sub-network. As both of the mobile devices implement this same policy they both arrive at the same number and thus create a single new inter-cluster subnetwork.

As they are the only mobile devices at the boundary between this new inter-cluster subnetwork and their respective clusters, they may immediately become named mobile devices and start to transmit routing information between these clusters and the inter-cluster subnetwork.

In the second situation, the mobile device R does not belong to an inter-cluster subnetwork, but the mobile device R₂ belongs to an already created inter-cluster subnetwork N.

The election policy may in this case look at the number of mobile devices belonging to this inter-cluster subnetwork. If this number is below a predefined threshold (for example, around 400), the mobile device R₂ asks the mobile device R to join the inter-cluster subnetwork N.

The routing means RM₂ of the mobile device may then be implemented to route the routing information within the inter-cluster subnetwork N.

As previously, the mobile device R may directly become a named mobile device, as it is the only mobile device forming the boundary between the cluster N₁ and the inter-cluster subnetwork N.

If the number of mobile devices belonging to the inter-cluster subnetwork N is above (or equal to) the threshold, the election policy may consider two sub-cases:

Either the mobile device R₂ is a named device and therefore no communication is possible.

Or mobile device R₂ is not a named device. In this last case, it may remove itself from the inter-cluster subnetwork N and create a new inter-cluster subnetwork whose only members are the devices R and R₂. This new subnetwork is created in the same way as in the case previously described.

In the third situation, the two mobile devices R and R₂ are already members of the inter-cluster subnetworks M (not shown on the figure) and N respectively.

In such circumstances the election policy may provide for several sub-cases:

In the first sub-case, the number of mobile devices that are members of the inter-cluster subnetworks N and M is below the threshold (this threshold may possibly be different for the two subnetworks).

In this case, the election policy may provide for a criterion for choosing which of the two mobile devices must remove itself from the corresponding inter-cluster subnetwork. This criterion may be a priority fixed in advance, the mobile device's processing capacity, etc.

The mobile device chosen to leave the inter-cluster subnetwork to which it belongs then joins the other inter-cluster subnetwork in a similar way to that described above.

In the second sub-case, the number of mobile devices within the inter-cluster subnetwork M has reached the threshold, although this number in the inter-cluster subnetwork N is below the threshold.

If the mobile device R is a named device, it may be considered that no communication is possible. Otherwise, the mobile device R leaves the inter-cluster subnetwork M and joins the inter-cluster subnetwork N. The way in which this mobile device R leaves a first subnetwork to join a second is similar to that previously described.

In the following situations, it is assumed that there is an inter-cluster subnetwork connecting the two clusters to which the mobile devices R and R₂ belong. These situations may be detected by each of the devices as the information messages exchanged contain the address of the other mobile device.

In the fourth situation, the two mobile devices R and R₂ do not themselves belong to an inter-cluster subnetwork.

In this situation, if the number of mobile devices belonging to the inter-cluster subnetwork connecting the two clusters has reached the threshold, no action is taken. Otherwise (the number is below the threshold), each of the two elements issues a request to join the inter-cluster subnetwork to its named device.

In the fifth situation, the mobile device R₂ belongs to an inter-cluster subnetwork other than that established between the two clusters. In such a situation, no action is taken.

In the sixth situation, the mobile device R₂ belongs to the inter-cluster subnetwork established between the two clusters.

If the number of mobile devices within this inter-cluster subnetwork has reached the threshold, no action is taken. Otherwise, the mobile device R joins the inter-cluster subnetwork.

In the seventh situation, the two mobile devices R and R₂ belong to two different inter-cluster subnetworks separate from a third inter-cluster subnetwork connecting the two clusters. In this situation, no action is taken.

Propagation of Routing Information

In FIG. 3, the references indicate mobile devices and networks that are different from those described in FIGS. 1 and 2. FIG. 3 shows two clusters N₁ and N₂. Cluster N₁ contains three mobile devices R, Rₐ and R_{b}. The device R does not belong to an inter-cluster subnetwork. The devices Rₐ and R_{b} belong to an inter-cluster subnetwork N. Only the mobile device Rₐ is a named device.

This inter-cluster subnetwork connects the cluster N₁ to another cluster N₂.

The cluster N₂ consists of the mobile devices R_{c}, R_{d}, Rₑ and R_{f}. The mobile devices R_{c}, R_{d} and Rₑ also belong to the inter-cluster subnetwork N, whereas the mobile device R_{f} is part of an inter-cluster subnetwork N′. Of the mobile devices R_{c}, R_{d} and Rₑ, only the mobile device Rₑ is a named device.

The mobile device R_{f} is the only device that belongs to both the cluster N₂ and the inter-cluster subnetwork N′. It is also a named mobile device.

This named device R_{f} transmits an information message in cluster N₂ and in inter-cluster subnetwork N′. According to one alternative, this information message is a distributed, or “multicast”, message.

According to one alternative, these information messages may consist of:
A named device identifier (a number, for example),
Optionally, a device priority, or any other mechanism allowing a named device to be determined if there are several possible candidates,
An inter-cluster subnetwork identifier, for which the device is the named device,
The number of devices belonging to the same cluster and to the same inter-cluster subnetwork,
The list of all the known inter-cluster subnetworks.

In the situation described, the mobile device R_{f} will therefore transmit an information message indicating:
Its identifier,
Optionally, a device priority, or any other mechanism allowing a named device to be determined if there are several possible candidates,
That it is the named device for the inter-cluster subnetwork N′,
That the number of devices belonging to the same cluster and to the same inter-cluster subnetwork is zero,
That the list of all the known inter-cluster subnetworks (except for the inter-cluster subnetwork N′ as this is indicated elsewhere) is empty.

This information message is received by the mobile devices of cluster N₂, specifically R_{c}, R_{d} and Rₑ. The device Rₐ, which is a named device, in its turn transmits an information message within both the cluster N₂ and the inter-cluster subnetwork N. It also updates its internal list of known inter-cluster subnetworks.

The information message transmitted by the named mobile device R_{f} indicates:
Its identifier,
Optionally, a device priority, or any other mechanism allowing a named device to be determined if there are several possible candidates,
That it is the named device for the inter-cluster subnetwork N,
That the number of devices belonging to the same cluster and to the same inter-cluster subnetwork is equal to 2,
That the list of all the known inter-cluster subnetworks (except for the inter-cluster subnetwork N) consists of the identifier of the inter-cluster subnetwork N′.

As previously, this information message is received by the mobile devices belonging to the inter-cluster subnetwork N and in particular by the named device Rₐ. This updates its internal database of known subnetworks and transmits its own information message, within both this same subnetwork N and the cluster N₁.

Thus, the mobile device R₁ ends by receiving an information message from the named device Rₐ. It then knows that within the network there are two inter-cluster subnetworks. The first, N, is described as “attached”, as it can be directly accessed by its named device. The other, N′, is considered to be remote as it is part of the list of known subnetworks in the information message and because no other information messages received refer to it as an “attached” subnetwork (i.e. originating from a mobile device named for it).

1. A mobile network device comprising communication means for transmitting data packets to one or several other mobile devices within a first cluster within a mobile communication network, according to routing information exchanged with said other device(s) through first routing means (RM 1) in accordance with a first routing protocol; and detection means (DM) for detecting a new mobile device belonging to a second cluster within said mobile communication network, said device further comprising:
Election means (EM) for determining, in accordance with an election policy, whether said new mobile device should or should not be added to the membership of an inter-cluster subnetwork,
Second routing means (RM2) for transmitting routing information between the mobile devices that are members of said inter-cluster subnetwork,
Communication means (CM) for transmitting the routing information exchanged by said first routing means to the mobile devices that are members of said inter-cluster subnetwork, and for transmitting to said first routing means the routing information received from said mobile devices that are members of said inter-cluster subnetwork, as well as information relating to said inter-cluster subnetwork, in accordance with a second routing protocol.

2. A mobile network device according to claim 1 also including a naming means (NAMM) for determining whether said communication means (CM) should or should not be implemented in accordance with a naming policy.

3. A mobile network device according to claim 1, in which said first routing protocol and said second routing protocol are proactive.

4. A mobile network device according to claim 3, in which said first routing protocol and said second routing protocol are similar and in particular are of the TBRPF or OLSR type.

5. A mobile network device according to claim 2, in which if said communication means is implemented by the naming means (NAMM), said routing information contains information messages comprising:
An identifier of said mobile device,
An identifier of said inter-cluster subnetwork,
The number of mobile devices belonging to said cluster and to said inter-cluster subnetwork,
The list of all the known inter-cluster subnetworks.

6. A process for transmitting data packets from one mobile network device to one or several other mobile devices within a first cluster or within a mobile communication network, according to routing information exchanged during a first stage with said other devices by means of first routing means (RM1) in accordance with a first routing protocol, said process including a stage comprising the detection of a new mobile device belonging to a second cluster within said communication network, which also includes the following stages:
Election to determine, according to an election policy, whether said new mobile device should or should not be added to the membership of an inter-cluster subnetwork,
Transmitting of routing information between the mobile devices that are members of said inter-cluster subnetwork,
Communicating of the routing information exchanged during said first stage, to the mobile devices that are members of said inter-cluster subnetwork, and transmitting to said first routing means of the routing information received from said mobile devices that are members of said inter-cluster subnetwork, as well as information relating to said inter-cluster subnetwork, in accordance with a second routing protocol.

7. A process according to claim 6, also including a naming stage for determining whether said communication stage should or should not be implemented according to a naming policy.

8. A process according to claim 6, in which said first routing protocol and said second routing protocol are proactive.

9. A process according to claim 6, in which said first routing protocol and said second routing protocol are similar and in particular of the TBRPF or OLSR type.

10. A processing according to claim 7, in which if the communication stage is implemented, said routing information contains information messages comprising:
An identifier of said mobile device,
An identifier of said inter-cluster subnetwork,
The number of mobile devices belonging to said cluster and said inter-cluster subnetwork,
The list of all the known inter-cluster subnetworks.

11. A communication network comprising mobile devices, which is formed from a set of clusters interconnected by inter-cluster subnetworks, each mobile device within said clusters exchanging routing messages through first routing means with other mobile devices within their cluster, and some of said mobile devices also exchanging routing messages through second routing means with the mobile devices belonging to an inter-cluster subnetwork.

12. Software able to be used on a communication network device and to implement a process according to claim 6.
